(19) United States
(12) Patent Application Publication
(10) Pub. No.: US 2005/0289593 A1
(43) Pub. Date: Dec. 29, 2005

(54) Method and system for displaying and selecting content of an electronic program guide

(75) Inventor: Michael Spilo, Greenwich, CT (US)

Correspondence Address: DARBY & DARBY P.C., P. O. BOX 5257, NEW YORK, NY, 10150-5257, US

(73) Assignee: Skipjam Corp., Port Chester, NY (US)

(21) Appl. No.: 11/140,471

(22) Filed: May 26, 2005

Related U.S. Application Data
(60) Provisional application No. 60/574,775, filed on May 26, 2004.

(51) Int. Cl. G06F 13/00; G06F 3/00; H04N 5/445

(52) U.S. Cl. 725/45; 725/46; 725/44

(57) ABSTRACT

A method of presenting an interactive electronic program guide (EPG) in a hierarchal data form which interactively allows users to find content more quickly. Search results of the EPG are stored in data records which are associated with meta criteria based on functional interrelationships. The method depicts the selections available to a user, and interacts with a user's selection by moving laterally, upward, or downward through the hierarchal format. Information is organized in a more useable manner by grouping channels into categories. Additional methods remove shows already recorded by a user based on information maintained in a database.

### CLAIM OF PRIORITY

This application claims priority under 35 U.S.C. § 119 as a continuation of Provisional Application Ser. No. 60/574,775, filed May 26, 2004 and titled “METHOD AND SYSTEM FOR DISPLAYING AND SELECTING CONTENT OF AN ELECTRONIC PROGRAM GUIDE,” which is hereby incorporated by reference in its entirety.

### FIELD OF INVENTION

The present invention relates to an electronic program guide which provides a user with schedule information. More particularly, it relates to a method for displaying and selecting the content of electronic program guides and guide information provided by multiple sources, e.g. in a multi-source television distribution system such as broadcast, cable, and/or satellite TV. The invention furnishes an interactive hierarchal data tree that provides the viewer with a more versatile, readable, and aesthetically pleasing display of program listings.

### BACKGROUND OF THE INVENTION

It is known in the art to provide an electronic program guide (EPG) which provides the viewer with an on-screen listing of upcoming television programs on television channels available to the viewer. In one implementation, the EPG is provided by an EPG data service and the EPG data is converted into a video signal at the cable head end and transmitted to the viewer's television via a dedicated cable television channel. After tuning to the dedicated cable television channel, the viewer must then passively wait until the program information for the desired time period and/or channel is displayed. This technique provides no mechanism for allowing the viewer to scroll through the EPG to the desired listing. Desired programs also cannot be selected directly from this list. Moreover, this technique also requires the cable head end operator to dedicate a separate cable television channel to the EPG data and to create video signals from the EPG data provided by the EPG service provider.

In another implementation, EPG data is transmitted to subscribers using either in-band or out-of-band signaling. The subscriber's home communication terminal receives the EPG data, and may store the data, so that the data is available when the subscriber requests program information. When requested, the EPG data is displayed on the subscriber's television, for example overlaid on or in place of the video programming. When the EPG is stored locally at the subscriber's television, the subscriber may scroll through the program information in the EPG until the desired listing is reached. In some embodiments the guide is interactive, and may allow particular programs to be selected.

Interactive program guides allow the user to navigate through television program listings using a remote control. In a typical program guide display, television listings are organized into subsets of listings according to multiple organization criteria and are sorted in various ways. One approach is to organize program listings into a program listings grid. Each row in the grid contains television program listings for a different channel. The columns in the grid correspond to a series of scheduled broadcast times. The user can scroll up or down to view program listings for different channels or may pan left or right to view information about programs being broadcast at different times.

Digital storage devices can be associated with the program guide providing the user with additional capabilities. A user then has the ability to store information associated with recorded programs in a directory in the digital storage device, thereby providing easy access to program information. In addition to displaying the EPG, a global media library indicating the programs stored on removable storage media can be displayed.

Prior art methods sort and display EPG data based on criteria selected by a user. The criteria can be by a general category (e.g., movie, situation comedy, news broadcast, etc.) or by the specific title of a show.

What is lacking in the art is a system and method of providing an EPG containing program content based on user selected criteria that is displayed in an interactive format capable of depicting functional relationships which exist among the search results. This and other needs are satisfied by the present invention.

### SUMMARY OF THE INVENTION

In accordance with one aspect of the invention, a method of generating television guide information for presentation to a viewer comprises the steps of electronically receiving schedule guide information from at least a first source, comparing the schedule guide information to either predefined criteria or user selected criteria, storing the comparison results in a database comprised of data records, creating functional relationships among the stored data records, arranging the data record contents as a hierarchal data tree, and displaying the hierarchal data tree on a display device.

In accordance with another aspect of the invention, schedule information for duplicated programs are associated with the data records and are presented as sub-objects in the hierarchal data tree.

In accordance with yet another aspect of the invention, the elements of the hierarchal data tree are rearranged based on functional relationships contained in meta criteria associated with the program.

These and other aspects, features, steps and advantages can be further appreciated from the accompanying drawing Figures and description of certain illustrative embodiments.

### BRIEF DESCRIPTION OF THE DRAWING Figures

FIG. 1 illustrates a block diagram of a conventional electronic program guide system;

FIG. 2 illustrates a conventional multi-source television program and television schedule guide system;

FIG. 3 illustrates a first process embodying the present invention;

FIG. 4 illustrates a process for identifying program content on a multi-source television system;

FIG. 5 depicts a hierarchal tree produced by the process of FIG. 3;

FIGS. 6-13 depict screen shots of an interactive user interface presenting the hierarchical format of an embodiment of the present invention; and

FIG. 14 illustrates a process of another embodiment of the present invention.

### DETAILED DESCRIPTION OF THE ILLUSTRATIVE EMBODIMENTS

By way of overview and introduction, a system and method for providing an electronic program guide (EPG) is presented. The electronic program guide is displayed in the form of an interactive hierarchal data tree that is capable of presenting functional relationships among its elements. User selected criteria including program themes or genre, time-slot groupings, or content provider (channels and/or source) are used to search a database containing all available programs to create the hierarchal data tree.

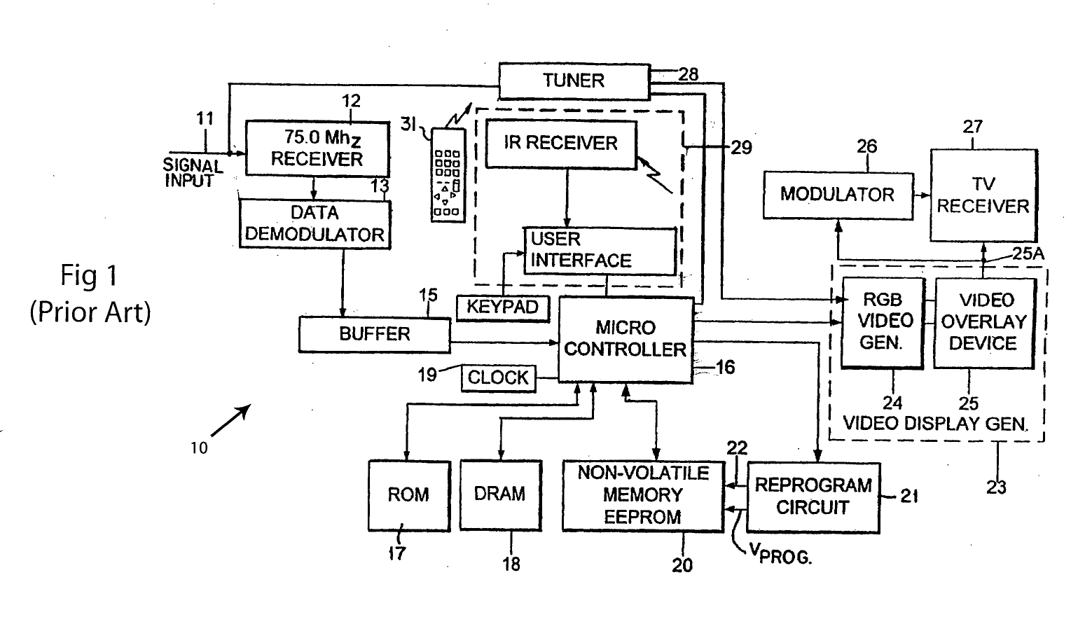

A conventional implementation of an electronic program schedule system is disclosed in U.S. Pat. No. 6,331,877 to Bennington et al., and is titled “Electronic Television Program Guide Schedule System and Method.” U.S. Pat. No. 6,331,877 is hereby incorporated in its entirety by reference. FIG. 1 is a block diagram showing various components of the electronic program schedule system 10 disclosed in Bennington et al. These various system components can be physically located in a set-top cable converter box, a satellite receiver; included as part of a television receiver, VCR, personal computer, or multimedia player; or reside as a distributed application in a broadband network architecture.

An input signal 11 is provided to receiver 12. This input signal 11 may originate, for example, from or as part of a standard broadcast, cablecast or satellite transmission. Along with programming content, the input signal includes a data stream which may contain, for example, information about programs or services available in a particular market. The data provider is a program information provider, the satellite uplink manager, a local cable operator, or a combination of these sources, and the data stream contains program schedule information for all television programs and other services available in the operator's geographical market.

The data stream may be modulated and then transmitted on the cable line in any number of ways, including as part of a dedicated channel transmission operating at a frequency of, for example, 75 MHz. Those of skill in the art will understand that numerous other transmission schemes can be used to transmit the data stream, such as embedding it in the vertical blanking interval (VBI) of a program broadcast signal. The transmitted data stream may additionally contain application software for implementing or updating the electronic program guide at the user site.

The transmitted program schedule data or application software is received by the receiver 12 on signal input line 11. The received signal is passed from the receiver to a data demodulator 13, such as a quadrature phase shift keying (QPSK) demodulator, which demodulates the transmission and passes it to a buffer 15. A microcontroller 16 receives data passed to the buffer 15. Bootstrap operating software, which may be used for capturing electronic program guide application software updates, is stored in a read only memory (ROM) 17. The microcontroller 16 uses the received program schedule information to build a database by storing the data in appropriately organized records in dynamic random access memory (DRAM) 18. The stored schedule information can be updated on a periodic basis, such as hourly, daily or weekly, or at any time when changes in scheduling or other factors warrant an update. The system also includes a system clock 19. Alternatively, the program schedule information could be supplied in a ROM, disk or other non-volatile memory, or it could be downloaded to a storage disk or other data storage device.

A user may navigate through the program schedule system with a remote controller, which operates on conventional principles of remote control transmitter-receiver logic, such as by infrared or other signaling, or other suitable user interface. The remote controller 31 communicates with the microcontroller 16 through the remote controller receiver 29, shown in FIG. 1, which can be an infra red receiver and which receives signals transmitted by the remote controller 31 and supplies the microcontroller 16 with a corresponding digital signal indicating the key depressed by the user.

The system components identified in connection with FIG. 1 can all be implemented in a personal computer equipped with a transmission link and a video graphics card, a cable converter box equipped with a microprocessor and memory, or a broadband network. In any event, those of skill in the art will appreciate that the particular details of the hardware components and data storage are a function of the particular implementation of the electronic program schedule system.

Other known implementations of an electronic program schedule system are disclosed in U.S. Pat. No. B1 4,706,121 (Reexamination Certificate) to Young; U.S. Pat. No. 5,038,211 to Hallenbeck; U.S. Pat. No. 5,629,733 to Youmans et al.; and U.S. Pat. No. 6,470,497 to Ellis et al., which are all hereby incorporated by reference in their entirety. Systems and methods which embody the present invention are described below and are not limited to a particular method of transmission or reception of the schedule information itself.

Regardless of what particular technology is used to implement the electronic program schedule system, a common implementation of an electronic program guide channel utilizes a dedicated cable television channel for continuously broadcasting program schedule information. The television viewer simply tunes the cable converter box or television tuner to the channel on which the schedule information is modulated and views the program listings. Typical program guides utilize a scrolling display grid showing the television listings. Generally the grid, or matrix, displays the program schedule information, with a different row for each channel and columns representing different time slots.

These prior electronic program guide systems have deficiencies that contribute to their limited use by viewers. For example, only a few rows (channels) are typically displayed on-screen at one time, and the rows are scrolled either continuously or periodically at a predetermined rate. A continuously scrolling program guide can be difficult to read because a viewer's eyes must follow the listings as they move up the screen. In addition a user expends quite a few minutes waiting to complete one cycle through the listings for all the channels, particularly in a cable system with a large number of channels. The time expended by a user in locating a program increases when the user has access to multiple sources of programming, e.g., conventional over air broadcast, cable broadcast, direct broadcast, satellite broadcast, etc.

These deficiencies have been addressed in the prior art to some extent. For example, U.S. Pat. No. 5,559,548 to Davis et al., titled “System and Method for Generating An Information Display Schedule for an Electronic Program Guide” discloses providing an interactive cable converter box to viewers. The interactive cable box has additional processor and memory capabilities which allow for the program schedule information to be downloaded and stored in the converter box. The user can then control the guide locally by selectively displaying program schedule information, as opposed to waiting for the desired information to appear on the television screen. U.S. Pat. No. 5,559,548 to Davis et al. is hereby incorporated by reference in its entirety.

U.S. Pat. No. 6,005,631 to Anderson, et al., which is hereby incorporated by reference, is titled “Methods and Apparatus for Organizing and Searching An Electronic Program Guide.” The '631 patent discloses an approach in which a single program descriptor is assigned to each program in the electronic program guide (EPG) data. The descriptor is transmitted to a home communications terminals, e.g., a cable converter box, satellite receiver, etc. A relationship is then separately established between these descriptors and one or more criteria supplied by a user to search the EPG data for programs of interest. The programs which are determined to meet the criteria may be displayed on the television of the subscriber.

Typical descriptors (also referred to as “categories”) include “movies”, “sports”, “comedy”, and “western”, as well as many others. A list of programs is limited to those programs matching a specified descriptor can be generated. Each of these categories has one or more subcategories. For example, “all”, “action”, “comedy”, and “western” are subcategories of the main category “movies” and “all”, “movie”, and “sitcom” are subcategories of the main category “comedy”. A program such as “Blazing Saddles” would appear under the categories movies: all; movies: comedy; movies: western; comedy: all; and comedy: movies.

Other EPG systems search for a particular program title entered by a user. U.S. Pat. No. 5,629,733 to Youmans et al. (previously incorporated) discloses just such a system. This approach is useful in systems having a large database of program schedule information (e.g., a large number of sources, channels, or days of programming). U.S. Pat. No. 5,479,268 to Young et al., hereby incorporated by reference, titled “User Interface For Television Schedule System” discloses interactive theme function screens which allows a user to quickly sort a downloaded schedule and display a subset schedule based on a subject of interest. The user can sort listings first by major themes (movies, sports, specials, TV fare), second by topic(s) within a theme (for the movie theme: foreign films, action/adventure, comedy, science fiction, etc.) and/or by topic qualifiers (e.g., motion picture ratings: G, PG, R, NR, etc.).

U.S. Published Applicant No. 2003/0154478 to Hassell et al., which is hereby incorporated by reference, is titled “Electronic Program Guide with Digital Storage Directory.” Hassell et al. discloses an EPG system provided with digital storage capabilities that gives users the ability to store information associated with a recorded program in a directory of the digital storage device. The user is then able to create a library indicating the programs stored in the device and/or on removable storage media. When a user indicates a desire to view television programming information, the program guide generates an appropriate EPG screen for display on monitor. The EPG screen may contain one or more lists of programs organized according to multiple criteria (e.g., by program type, theme, or any other pre-defined or user defined and selectable criteria) and sorted in various ways (e.g., alphabetically). One approach organizes the EPG into a program listings grid. By highlighting an element of the grid, a user obtains further information on the program which may include, for example, the title of the selection, a description, episode information, the channel, cast members, parental control ratings, categories, available language(s), available video formats, or other information like associated Internet web sites or computer software.

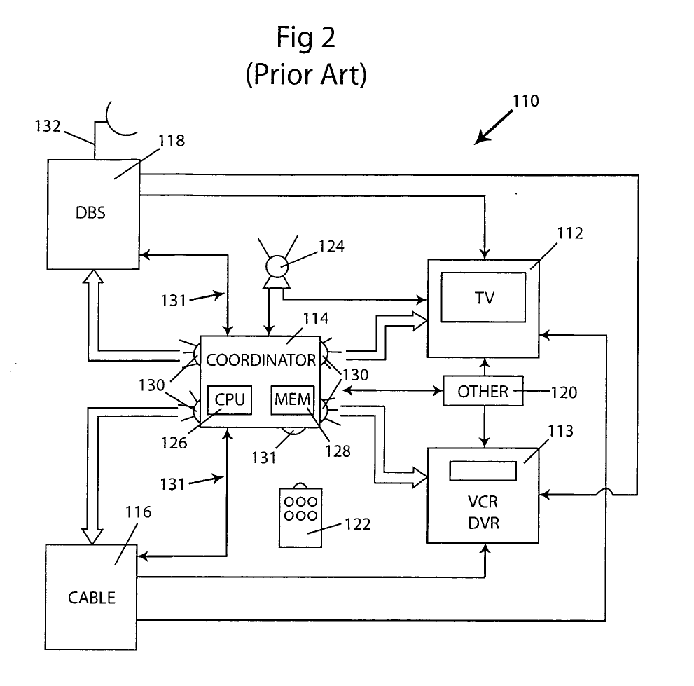

Another method for obtaining television schedule guide information from one or several sources is disclosed in U.S. Pat. No. 5,801,787 to Schein et al. titled “Television Schedule System and Method of Operation for Multiple Program Occurrences,” which is hereby incorporated by reference. Schein et al. discloses sources such as an incoming cable line (e.g., on a coax cable), satellite broadcasts, a dedicated telephone line (e.g., a twisted pair), and any other medium capable of transmitting a signal, such as a computer or modem line. The multisource schedule information is sorted and displayed to the user in an organized fashion to create a merged television guide. This merged guide information is used to identify when a particular show is to be played, even when it is not from the same source as another instance of the same show. FIG. 2 illustrates the prior art example of a multi-source television schedule guide system 110 with multiple sources connected directly or indirectly to a television 112 and/or VCR/DVR 113. In FIG. 2, multi-source television program and television schedule guide system 110 operates under the control of coordinator 114. Television 112 and VCR/DVR 113 are provided with inputs from cable box 116 and DBS source 118 either directly as illustrated in FIG. 2, or via coordinator 114. Other inputs 120 may also be supplied to the television and/or VCR/DVR directly or via the coordinator 114. A remote control 122 is used by a viewer to tune the television and conduct other operations. Other inputs 120 can include multiple satellite sources. When multiple satellite sources are present, coordinator 114 switches between the available satellite sources by automatically moving the user's satellite dish or switching between satellite dishes. In order to automatically move the satellite dish, a memory tracks the position of the DBS satellite dish in relation to satellite sources. The system automatically positions its satellite dish such that the desired satellite source is received.

While improvements have been made on the basic paper TV schedule listing and simple grid guides, the prior art, does not provide flexible category-based display and selection of program content. Conventional and known search systems typically yield too many, or too few results, leaving the user to browse through dozens of results in order to find shows of interest. Embodiments of the present invention provide search, display and selection methodologies which allow users to hone in on shows in a way not possible under the conventional systems. The information obtained by these embodiments is presented in a hierarchical manner which allows users to view only those parts of the search results that are of interest to them.

In one embodiment, search results are processed by a non-duplication algorithm that removes multiple entries for the same program that occur across multiple channels, time slots, or from multiple sources. The simplest embodiment of the non-duplication algorithm can be a process which locates a unique identifier common to each individual entry of the same program, where the unique identifier is embedded within the program guide content itself. In another embodiment of the non-duplication algorithm, the process identifies programming duplications by comparing program titles and descriptions.

A more sophisticated embodiment of the non-duplication algorithm can be a process which identifies factors that make a particular program unique, and compares these factors to programs being offered on other channels, time slots or sources. Such factors that are unique to a particular program can include the program's cast members, duration and rating; which in combination can be sufficient to distinguish between different programs. Other factors that can be used in this embodiment are channel, network affiliation, and other criteria that may be available from the EPG content; however these factors on their own might not conclusively distinguish among particular programs. Where the program description contains minimal information, it is possible that the algorithm might not be conclusive. In such an instance the more definitive identifiers of cast member, duration and rating need to be considered.

The non-duplication algorithm determines whether a program description is too minimal for a conclusive identification by quantifying how many identical matches exist in data fields for each program. As an example, where the category is sporting events, a match on all available data fields may not indicate a duplicate program; the same can be true of news programming. For Instance, a news program titled “Evening News” might very well occur daily on multiple channels at the same time, but this would not necessarily indicate that all similarly titled news programs are duplicate programming. The non-duplication algorithm can consider only the program title to identify and remove duplicate programming until the user selects the program by title, at which point the finer aforementioned distinctions can be used to identify duplicate programming.

The resulting EPG is less difficult and less time consuming for users to sort through when compared to the EPGs of the prior art. For example, suppose a user selects “science fiction” movies: an EPG of the prior art might present a list where the movie “The Matrix” occurs dozens of times on pay-per-view channels, movie channels such as HBO and network channels, and is simultaneously available from cable and direct satellite sources. The non-duplication algorithm sorts these results and presents a hierarchal tree displaying a top level result based on a pre-selected user viewing preference (based on broadcast time, source of content, etc.). A user can expand the tree to select from other possible search results. In this way, related results can be grouped and displayed once, together, or in a hierarchy, rather than simply as different or independent listings.

In one embodiment of the present invention, the multi-source television system is used to collect programming data for the multiple sources, for example using conventional methods of data collection. After data collection the programming information is analyzed and categorized under criteria entered or selected by a user, or according to predetermined or default criteria. Analysis not only identifies the themes and sub-themes of the programming content, as described above, but also includes a determination of the program source (e.g., conventional broadcast, direct satellite broadcast, etc.) as well as its point of ultimate origination (i.e., the actual network or station supplying the program). The analyzed and categorized results are displayed in a hierarchal data tree that has interactive capabilities to aid the user in selecting not only a particular program, but which instance of transmission for that particular program is to be viewed or recorded. Links to other related programming can also be made, for display and selection, again according to criteria set by the user, or according to predetermined or default criteria.

A person of skill in the art will understand that traditional software applications and computer systems provide graphical user interfaces (GUI) that are limited in their ability to represent multiple relationships between objects, which are represented as icons. For example, Windows Explorer provides a GUI that is limited to displaying icons (representing files and folders) that are arranged in a hierarchical format. This is because designers have developed Windows Explorer and other similar GUI applications over many years to take into account the parent—child data relationships that exist between files and folders (directories) in a file system. If a group of data elements have many interrelationships that are arranged in a non-hierarchical format, an application using a hierarchical-based GUI will have difficulty trying to graphically represent such relationships. This causes an application using such a GUI to be able to represent only a limited number of relationships within the interface at any given time.

However, advances have been made in the capabilities of presenting hierarchical relationships in a GUI. For instance, U.S. Pat. No. 6,636,250 to Gasser, titled “Methods and Apparatus for Presenting Information to a User of a Computer System” discloses a graphical relationship user interface (GRUI) which uses a hierarchical form to depict and display hierarchical and non-hierarchical relationships and objects. U.S. Pat. No. 6,636,250 is hereby incorporated by reference in its entirety. The system disclosed by Gasser performs a relationship function identified by a relationship selection chosen by the user. The relationship function is performed upon a descriptor in the system memory that is related, according to the relationship selection, to an icon displayed on a computer screen and chosen by the user. Certain relationship functions can be used to condense the view of a large number of icons into a shorter sub-list of icons. This provides a more concise view for the user and allows more relationship information to be displayed in a smaller display area. When a collapsed icon is expanded, a sub-list of other icons is displayed underneath and indented to the right of the expanded icon.

In one embodiment of the invention, electronic program guide (EPG) information is received from at least one source. The source may be a cable television provider, satellite network, or other content provider. The EPG information contains descriptions of the content. These descriptions typically contains the program genre (e.g., comedy sitcom, drama, new, sports, home improvement, etc.), the program length, the nature of the program (e.g., broadcast, movie, premium movie, pay-per-view, etc.), and information on the particular source of the program (e.g., broadcast network, premium channel, independent channel, etc.).

In this embodiment a database is populated with the program data just described. An individual record of the database can be populated with all the program content data available from one content provider, with additional records containing the data from other content providers. Alternatively, multiple records of the database can be populated with the information from a content provider. The methods and techniques of distributing data among the records of a database is well known in the art. The present invention contemplates any such data distribution scheme, and is not limited to any one such scheme.

The records of the database are mined to create associations among the data. These associations are based on common interrelationships among the program content and include, but are not limited to, the time of broadcast (e.g., primetime, daytime, late night), the program genre (e.g., sitcom, western, drama, etc.), the nature of the broadcast (movie, live, prerecorded, repeat, etc.), and the source of the broadcast. Meta tags are created to represent the criteria which forms these associations.

The meta criteria are searchable to determine which program content has the same interrelationship, and the results of the search are formed into a hierarchical format. The search is performed in response to a user selection of one, or more, criterion. The search can also be based on a predetermined criterion. The use of the meta tag criteria allows for dynamic relationships to be formed among the database records. All combinations of criteria are possible for display in the hierarchical format. The interrelationships are defined and reorganized as a user “drills down” through the hierarchy. Additionally, the interrelationships can be used not only to include program content in the hierarchy, but also to exclude content.

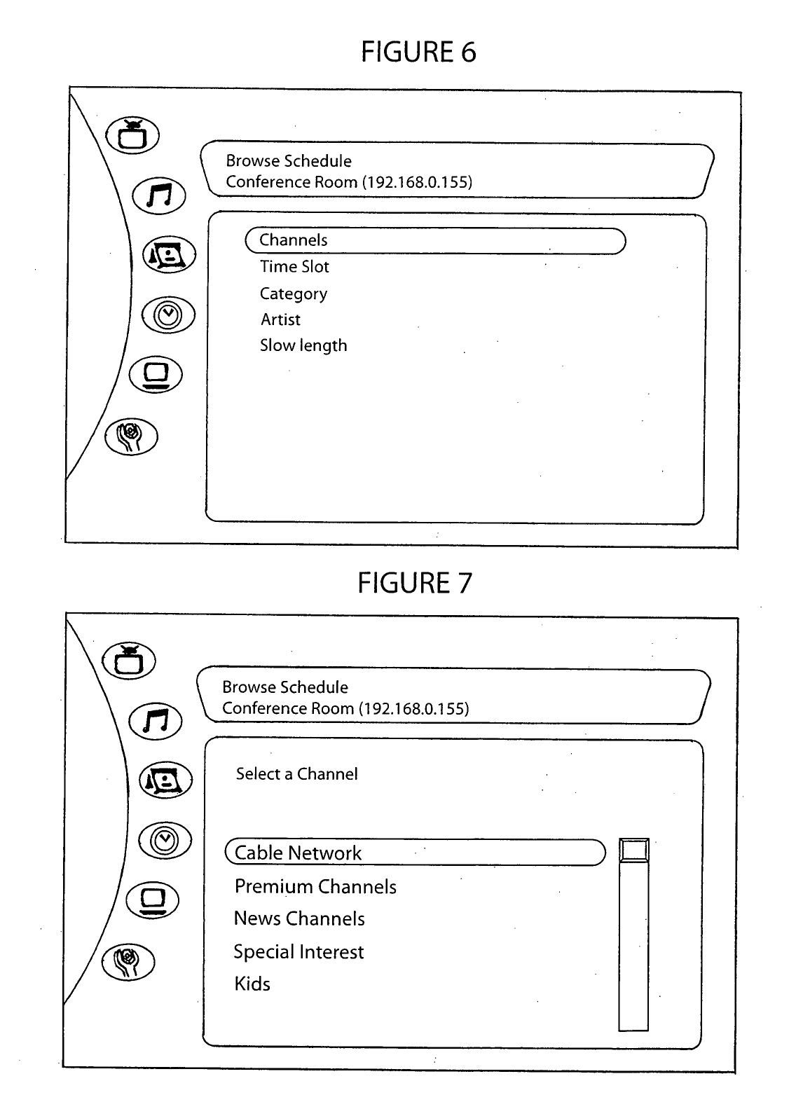

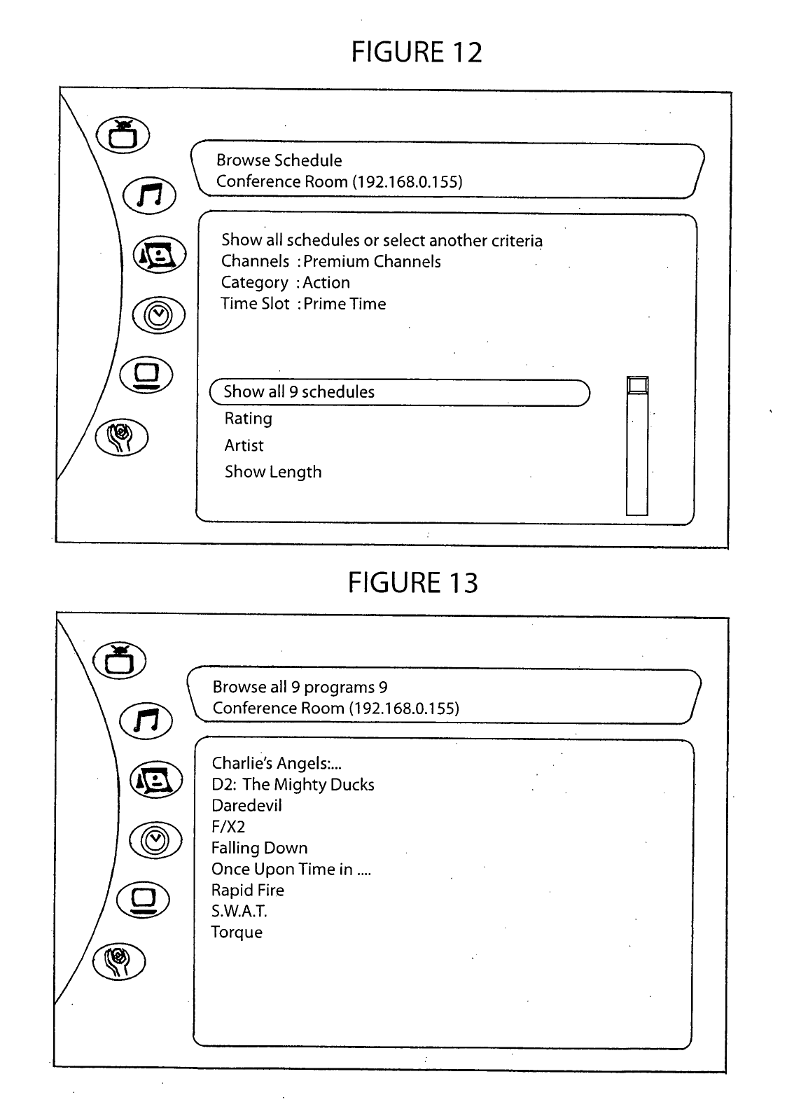

FIGS. 6-13 depict screen shots of an interactive user interface that presents the hierarchical format of an embodiment of the present invention. The interactive user interface includes a display device and an input device. The interactive user interface can be a desktop or laptop computer, a personal digital assistant, a handheld computer, or a workstation. The display can also be a touch screen, thus combining the display and input device into one unit.

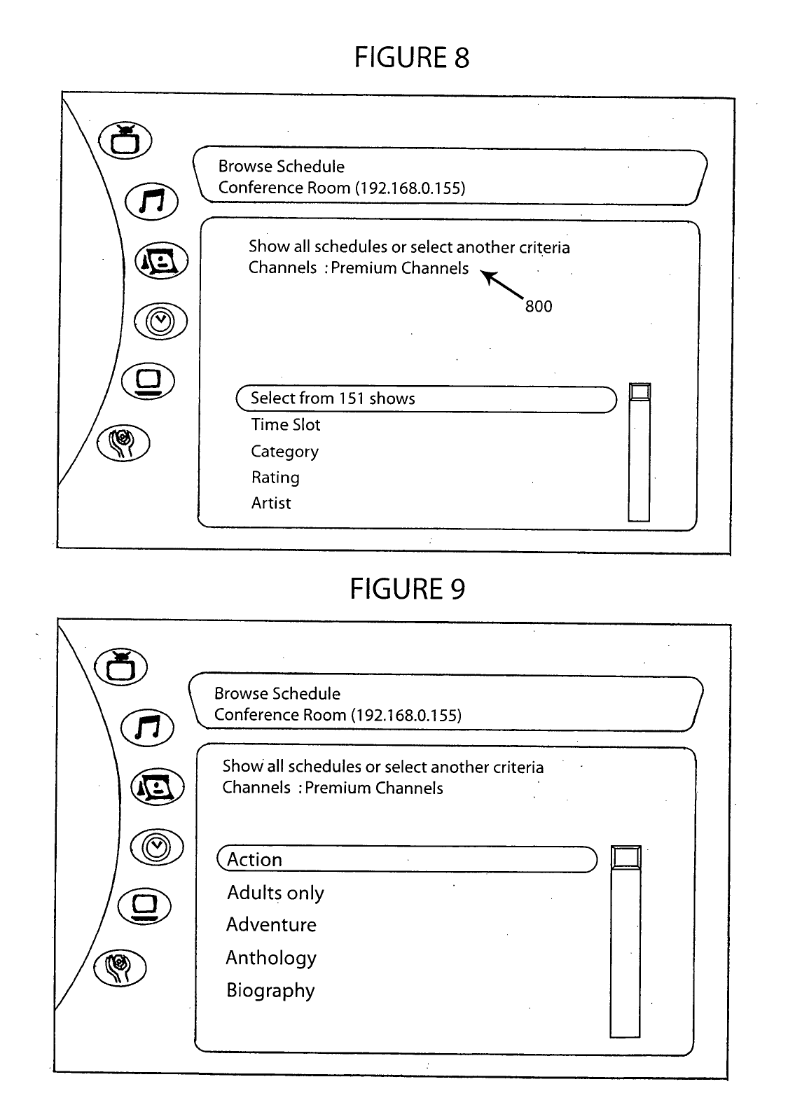

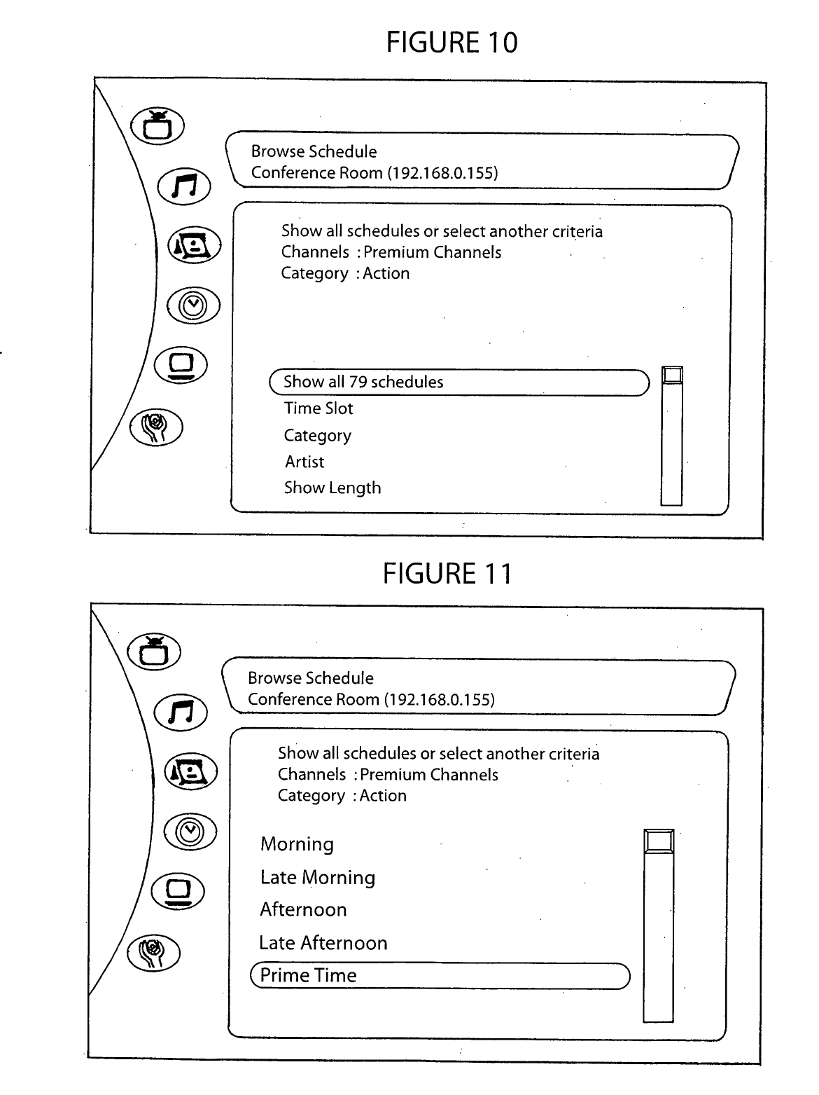

As shown in FIG. 6, a user is presented with a selection of criteria, from which the content data will be organized. Here, as an example, the user has selected “Channels,” and as depicted in FIG. 7, a selection of channels is presented. FIG. 8, depicts, in message area 801, that the user has so far selected Channels: Premium Channels. The user is presented with various choices to further narrow the presentation of the available program content. Either all 151 shows can next be presented, or the user can select from time slot, category, rating, and artist. FIG. 9 depicts the selection of categories available under Premium Channels. FIGS. 10-13 illustrate the presentations as the user further “drills down” through the hierarchical format to make a selection.

A person of ordinary skill in the art will recognize that there is a significant overlap of program content among the selection categories. For example, a sitcom can be under comedy, have a particular timeslot, a desired artist, or be broadcast on a particular content provider. As the user makes selections, the interrelationships among the database records is reorganized and the present invention dynamically reorganizes the hierarchical format to accommodate these user selections.

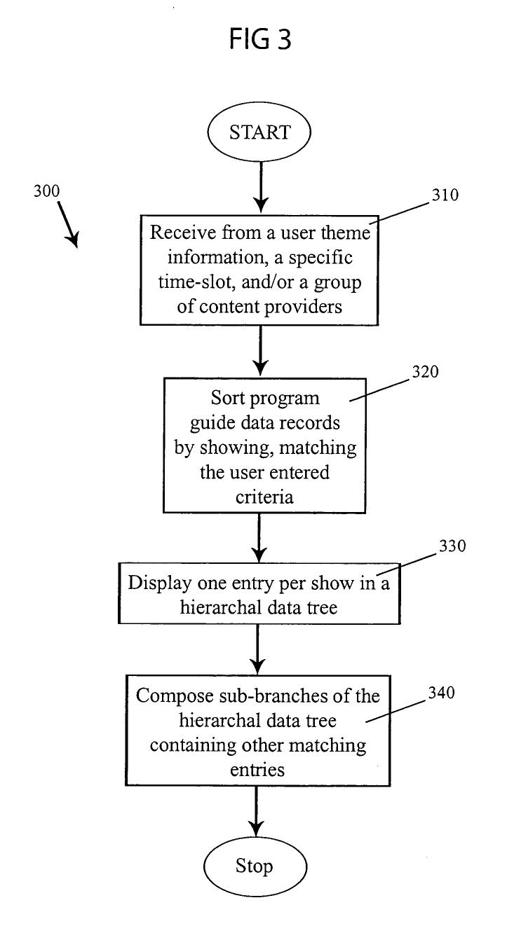

FIG. 3 depicts Process 300, which is an embodiment of the invention. The process performs a non-duplication algorithm that identifies and selectively removes or “hides” multiple entries for the same program occurring across multiple channels, time slots, or from multiple sources. A user of Process 300 specifies a specific time-slot and a group of content providers (channels). Meta categories containing program themes and providers are also selectable by the user. Process 300 sorts the program guide data by the user selected criteria and, at least initially, displays one entry per show. The display can be sorted by network and/or genre (theme). For multi-source television systems, Process 300 recognizes the same channel across the multiple sources and combines the results to display just one instance for an identical show airing at an identical time.

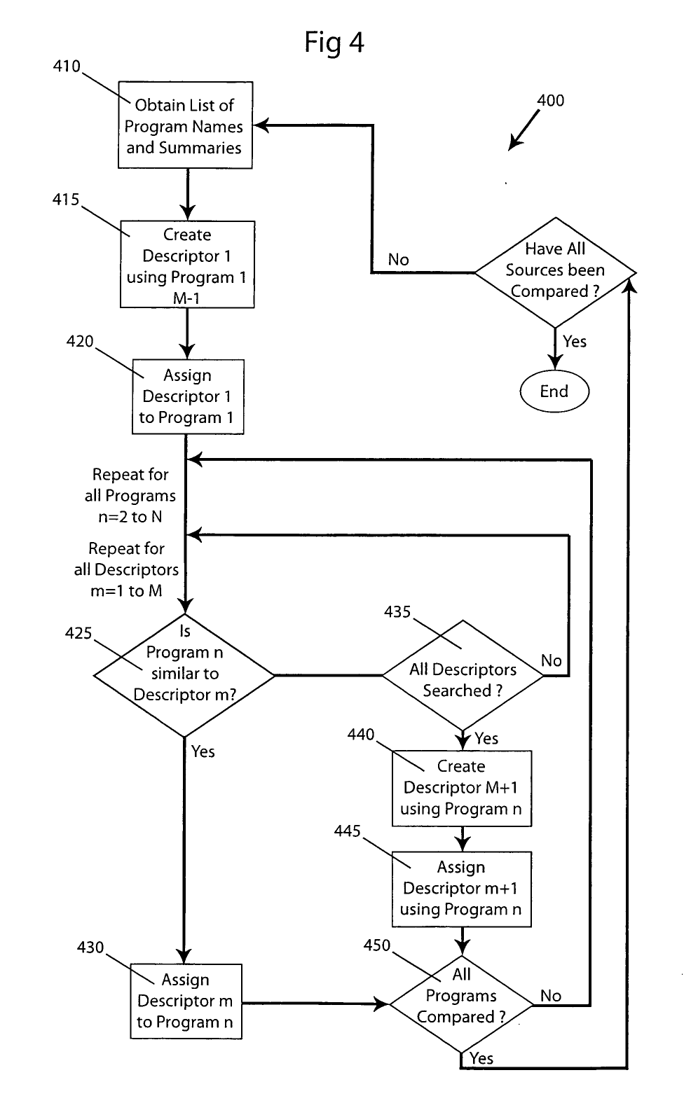

Referring now to FIG. 4, a process is illustrated which identifies the program content provided over a plurality of channels in a multi-source television system. Transmitted program schedule data is obtained from the content provider (block 410). The program data at least includes program names and may further include program summaries containing keywords which are used to form a meta page for the program. The meta page also contains the broadcast time for the program. Database records, located in a data store that is part of the multi-source television system, are created and used to store the program name and meta information for each program in the program schedule (block 415). A first program data record is then assigned to the first program in the program list (block 420). Next, a second program on the program schedule is compared to the first data record and a decision is made as to whether the second program is identical to the program named by the first data record (decision block 425). The decision regarding similarity of programs may be based on program content using the meta information contained in the program summary for the programs in the program schedule. For example, the decision at decision block 425 may take into account the program air date and time, its channel, as well as its genre or theme.

If, at decision block 425, it is decided that the second program on the program list is identical to the program named by the first data record, the first program data record is assigned to the second program (block 430). However, if the air date and time are not the same, a sub-object indexed to the second program is added to the data record. A decision is then made as to whether all the programs in the program schedule have been compared to the program data records (decision block 450). If not, the procedure is repeated until all N programs on the program schedule have been processed. If so, the procedure is complete. If, at decision block 425, it is decided that the second program is not similar to the program corresponding to the first data record, a decision is made as to whether all the data records have been searched (decision block 435). Because, at this time, only one program data record has been generated, a new second data record is generated using the program name of the second program (block 440). The second data record is then assigned to the second program (block 445). Next, a decision is made as to whether all the programs in the program schedule have been compared to the program data records (decision block 450) as mentioned above. If not, the procedure is repeated until all N programs on the program schedule have been processed. If so, the procedure repeats itself for each of the multiple sources present on the television system (decision block 460).

When repeating the process for the multiple sources, data records are updated to indicate when the same identical show is made available from the same channel at the same time, but from different sources. A channel is a carrier signal providing program content and is transmitted to the user by one or more sources. Sources can be conventional over-air broadcast, cable broadcast, direct satellite broadcast, or other transmission technologies such as telephony and internet that can provide the channel to the user. Once all program schedules for all sources have been compared, the process is complete.

Users can sort the content by specifying “meta categories” which can be pre-defined, or by specifying directly the time slot or other category of interest. In a preferred embodiment the search methodology takes advantage of the cable and network TV custom of grouping popular shows by time slot targeted at particular audiences. For example, typically the 7 PM to 9 PM week-night slot is reserved for “family friendly” network shows, while the 9 PM to 11 PM is reserved for more mature content. Other categories include, but are not limited to “Prime-Time National Networks” which could include “ABC, CBS, NBC, FOX, WB” networks. Such a category could be expanded or narrowed based on the selection of “Cable Networks” such as “USA, TNT, etc.”

A user of the multi-source television system may receive cable broadcasts, satellite broadcasts and over-the-air broadcasts. These varied sources may provide multiple affiliates of the same network that air the same show at the same time. For example a user on the east coast could get NBC on channel 4 cable, channel 4 over the air, channel 52 digital TV over the air broadcast, channel 894 satellite NBC local, and channel 394 NBC West coast broadcast.

By recognizing that the above are all “NBC” programs (NBC is the network providing common content to its affiliate channels, which may be present on more than one source) either through a pre-defined list, through analysis of the call letters of the station and it's affiliation, or through analysis of the actual program name and description, these entries are all related to the same data record, reducing the results to a more manageable list. Thus, by sorting the multiple presentations by source and channel, with selective grouping and display, the bewildering array of recording choices for the same material can be reduced.

Referring again to FIG. 3, having now compiled the database containing all programs available from all channels present on all the sources of a multi-source television system as described in FIG. 4, the non-duplication algorithm embodied in Process 300 can proceed. The algorithm narrows the information stored in the data records that is initially presented to a user. For example, the user specifies, at step 310, a theme for content of interest, along with a user specified time-slot. The time slot can span a number of days, and be further limited by specifying a particular group of content providers (either by source or channel). At step 320, Process 300 sorts the program guide data records for entries containing matches to the user criteria. Process 300 tracks multiple entries that appear for the same show. These multiple entries are further sorted by the source (e.g., cablevision, direct satellite broadcast, etc.), channel, and time.

Process 300 continues to sort program guide data by show and, at step 330, builds a hierarchal tree to display one entry per show allowing the user to select recording preferences from the list presented. The list could also be sorted by network and/or genre and presented in order. The system could also be designed to recognize the same channel across multiple media, and/or to combine results for the same network where it is available on multiple channels.

The sub-data records of identical shows are placed into branches of the data tree, step 340. When a show of interest to the user is found, and that show occurs on multiple channels or time slots, the user can select from the data tree a particular program for recording. Additionally the user could be presented with the option of recording all occurrences of the show, or only those on a particular channel or time slot.

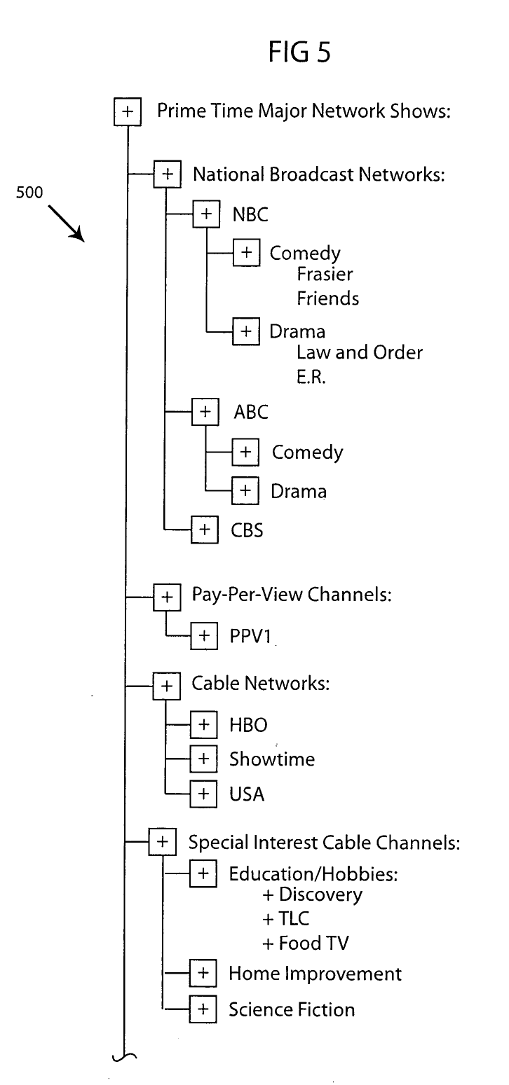

FIG. 5 illustrates a hierarchal tree 500 formed by Process 300. The “+” symbol is an indicator that denotes additional information is available as a subset of the displayed category. Using the relationship function of a GRUI, described above, the user could optionally turn on or “expand” the list, or turn off, or “collapse” a list, as desired—for example to refine the display list further and/or redefine which shows or channels belong in which categories.

In order to create a list of affiliated or related channels, in one embodiment a database of major channels available over-the air and on major carriers in each region of the country is present in the multi-source system. This database would include the provider, channel number or name and one or more categories into which a channel belongs. Examples of categories would be “NBC and affiliates” or “Education and special interest” and so on. When programs are sorted, they are sorted into by name and then by channel category.

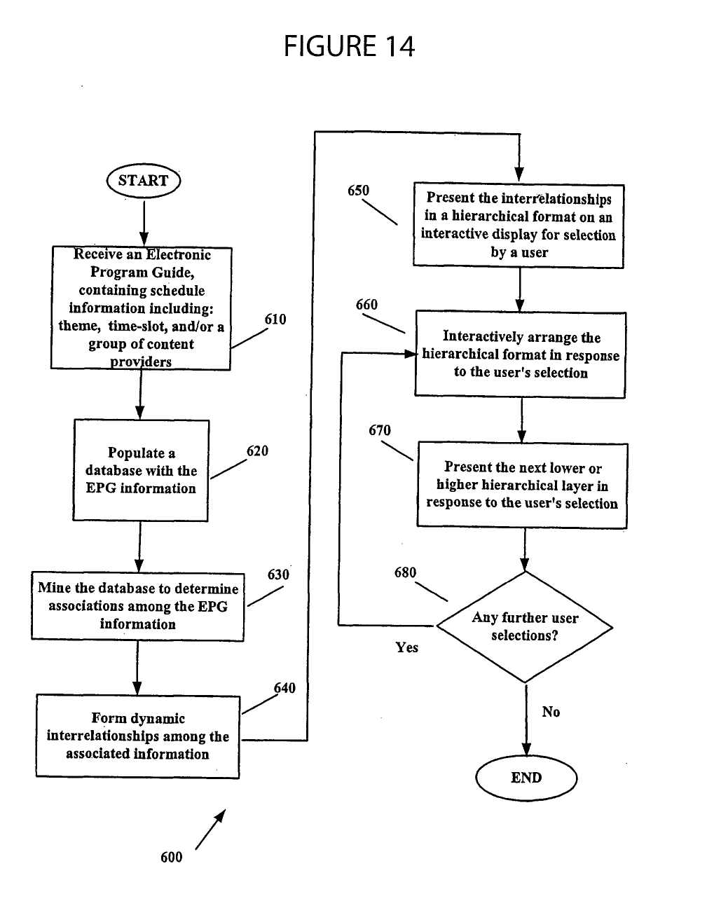

FIG. 14 depicts Process 600, which is another embodiment of the invention. The process forms dynamic interrelationships among data present in an EPG, assigns meta criteria to the data, and rearranges the data to present an interactive hierarchical selection in response to a user's interaction with the hierarchical presentation. At step 610, the process receives a EPG from a source. This source can be broadband cable television content provider, a satellite television content provide, or any other provider of television content. Alternatively, the source itself does not have to be the television content provider, but merely a source of the channel guide itself. Process 600, at step 620, populates at least one record of a database with the program schedule data. At step 630 the process mines the data and creates interrelationships among the data. The EPG data is mined for information regarding the theme or nature of the show, its broadcast network, the type of show, etc. Where possible, even the names of the actors can be mined from the EPG. At step 640, dynamic interrelationships are created among the mined data and associations are made between the database elements. Meta criteria is assigned to the database elements. In one embodiment, it is this meta criteria that facilitates the associations and the dynamic maintenance of the interrelationships. A hierarchical format is presented, step 650, on an interactive display device. One such format is shown in FIG. 5. Another format is depicted in FIGS. 6-13. The interactive display can be a touch screen, or a display associated with a pointing device, e.g., a mouse.

When a user makes a selection from the hierarchical format, at step 660 the process rearranges the hierarchy to reflect the user's choice. For example, FIG. 8 depicts an interactive display where a user can select to have premium channel shows arranged by time slot, category, rating, or artist. After the selection is made to have the premium channels arranged by category, at step 670, the process presents the next level of the hierarchy. FIG. 9 presents the premium channel show selections of Action, Adults Only, Adventure, Anthology, and Biography. Naturally, if the selection was made to go back one level, the process would present the hierarchy level above the presently viewed layer. If the user selections are not complete, step 680, the process returns to step 660.

In alternate embodiments, a method maintains an on-going list of all programs recorded by the user, and can automatically, or at a user's request, either (1) remove any program previously recorded from the hierarchal tree; or (2) remove previously recorded programs, but only if the programs are not “series” or “episodes” of an on-going show as determined by the program guide information; (3) remove the programs from being displayed on the tree if it is already slated for recording; or (4) remove the programs from the list if they are already slated for recording and are not series” or “episodes” of an on-going show as determined by the program guide information.

Thus, while there have been shown, described, and pointed out fundamental novel features of the invention as applied to several embodiments, it will be understood that various omissions, substitutions, and changes in the form and details of the devices illustrated, and in their operation, may be made by those skilled in the art without departing from the spirit and scope of the invention. Substitutions of elements from one described embodiment to another are also fully intended and contemplated. It is also to be understood that the drawings are not necessarily drawn to scale, but that they are merely conceptual in nature. The invention is defined solely with regard to the claims appended hereto, and equivalents of the recitations therein.

1. A method of generating television program guide information for presentation to a viewer, comprising the steps of:
receiving, from at least a first source, electronic program schedule information containing more than one field of data;
populating at least one record in a database with the program schedule data;
mining the database record to create associations among the data;
forming dynamic interrelationships between the associated data; and
presenting, in response to a user selection, the dynamic interrelated data in a hierarchical format on a display device.

2. The method of claim 1, further comprising the step of:
interactively rearranging the hierarchal format based on selections received from a user.

3. The method of claim 1, wherein the dynamic interrelationships are defined from one of a predefined and a user selected criterion.

4. The method of claim 3, wherein the user selected criterion is a member of the group consisting of theme, source, channel, and time-slot.

5. The method of claim 1, further comprising the steps of:
associating duplicative schedule guide information from at least a second source with the data records created in the populating step; and
presenting the duplicative information as a sub-object element in the hierarchal format.

6. The method of claim 5, further comprising the steps of:
removing duplicative program information for non-series and non-episode shows.

7. The method of claim 1, wherein the mining step further comprises the step of creating meta criteria for the data from the program schedule information.

8. A method of selecting television program guide content comprising the steps of:
electronically receiving program content data for a set of channels from at least a first source;
populating at least one database record with the program content data;
mining the database record to form associations among the data;
creating meta criteria for the data associations;
searching, upon a user's request; the meta criteria for all data associated in the mining step; and
presenting, in a hierarchical format, the results of the searching step on an interactive display device.

9. The method of claim 8, further comprising the step of changing, upon selection by a user, the presentation of the results;
wherein the presentation moves along the hierarchical format one of laterally, upwards, and downwards.

10. The method of claim 8, wherein the searching step searches the meta criteria based on at least one of a user or predetermined criterion.

11. A method of selecting television program guide content comprising the steps of:
electronically receiving schedule guide information for a set of channels from at least a first source;
selecting programs based on a specific time-slot over multiple days; and
narrowing the selection by limiting the set of channels to a particular sub-set.

12. The method of claim 11, wherein the time-slot and the multiple days are predefined or user selectable.

13. The method of claim 11, wherein the multiple days represents at least two consecutive days, for at least two consecutive weeks.

14. The method of claim 12, wherein the sub-set of channels is predefined or user selectable.

15. The method of claim 12, wherein the time-slot is a member of the group consisting of a 8 PM to 11 PM Monday through Friday, 2 PM to 5 PM Monday through Friday, 11 PM to 2 AM Monday through Friday, 6 AM to 11 AM Monday through Friday, and 8 PM to 11 PM Saturday through Sunday.

16. The method of claim 14, wherein the sub-set of channels is a member of the group consisting of broadcast network television channels, major cable network channels, news-only channels, and special interest channels.
